(19) United States
(12) Patent Application Publication
(10) Pub. No.: US 2013/0117819 A1
(43) Pub. Date: May 9, 2013

(54) COST-EFFECTIVE DEVICE FOR TRANSFERRING DATA UNIDIRECTIONALLY

(71) Applicant: INTERFACE9 INCORPORATED, Ashburn, VA (US)

(72) Inventor: Thuan L Thai, Ashburn, VA (US)

(73) Assignee: INTERFACE9 INCORPORATED, Ashburn, VA (US)

(21) Appl. No.: 13/656,693

(22) Filed: Oct. 20, 2012

Related U.S. Application Data
(60) Provisional application No. 61/556,251, filed on Nov. 6, 2011.

(51) Int. Cl. H02G 15/02; G06F 21/00; G02B 6/26

(52) U.S. Cl. 726/4; 174/74 R; 385/45

(57) ABSTRACT

Unlike excessively complex and extremely expensive methods in the prior art, this invention discloses a highly cost-effective and simple-to-use device for transferring data unidirectionally, allowing small businesses and home users to reap the benefits of advanced network security, which otherwise would have been affordable and attainable exclusively by commercial and federal entities. Because of its cost effectiveness and simplicity, the device of this invention makes it possible for every computer user to protect their internal networks from information thieves.

This application claims the benefit of Provisional Application No. 61/556,251, filed on Nov. 6, 2011.

### FIELD OF INVENTION

The present invention is in the technical field of computer security. More particularly, the present invention is in the technical field of protecting an internal network from information thieves.

### BACKGROUND OF THE INVENTION

Malware is so prevalent these days that some users have resorted to creating their own private, internal network where they can safely share data, music, and videos among devices in their isolated network without the fear of a downloaded malware sending stolen information back to its creator. A conventional way of doing this is to configure firewalls for this protection, but this process is time consuming and requires advanced technical diligence. A more assured technique for doing this is to intentionally inject a network gap that allows downloaded applications to be transferred into the internal network but prevents reverse communications, just in case a downloaded application executing in the internal network happens to be malware. Used almost exclusively by large commercial and federal entities, conventional methods (as disclosed in U.S. Pat. Nos. 5,703,562, 6,108,787, 6,718,385, 7,649,452, 7,675,867, and 7,992,209) for doing this are extremely sophisticated, unnecessarily complex, excessively expensive, and totally unattainable by small businesses, much less home users.

Instead of these overly expensive and unattainable methods, a cost-effective and simple device is needed for small businesses, including but not limited to medical, dental, and legal offices, to achieve the same level of assurance. These advantages should also make this device very appealing to home users who want to implement their own private, internal networks.

### BRIEF SUMMARY OF THE INVENTION

Unlike excessively complex and extremely expensive methods in the prior art, this invention discloses a highly cost-effective and simple-to-use device for transferring data unidirectionally, allowing small businesses and home users to reap the benefits of advanced network security, which otherwise would have been affordable and attainable exclusively by commercial and federal entities. Because of its cost effectiveness and simplicity, the device of this invention makes it possible for every computer user to protect their internal networks from information thieves.

The invention is a device that contains the circuitry to enable network traffic to move from a source to a target, but intentionally lacks the circuitry to allow network traffic to move from the target to the source. The source is where one would attach a network cord belonging to a source device, such as a computer. Likewise, the target is where one would attach a network cord belonging to a target device, such as a computer. Once attached, data may move only from the source computer to the target computer, but not in the reverse direction.

After the data is transferred to the target computer, it can be shared with any devices on the internal network. Because the device of the invention lacks the circuitry for reverse communications, no data from the internal network can be transferred to an external network, such as the Internet, thus inhibiting any accidentally downloaded malware from sending stolen information back to its creator.

### BRIEF DESCRIPTION OF THE DRAWINGS

FIG. 1 is a perspective view of the present invention, using RJ45 connectors.

FIG. 2 is a diagram showing an example usage of the present invention.

FIG. 3 is a diagram showing an example usage of the present invention, with unidirectional data transfers in both directions.

FIG. 4 is a diagram showing an example usage of the present invention, with daisy chaining to add multiple layers of security.

FIG. 5 is a diagram showing a way to wire up the source and target RJ45 connectors for the embodiment shown in FIG. 1.

FIG. 6 is a perspective view of an alternative embodiment of the present invention as illustrated in FIG. 1, this time using optical fiber connectors.

FIG. 7 is a diagram showing a way to connect the source and target optical fiber connectors for the embodiment shown in FIG. 6.

FIG. 8 is a perspective view of an alternative embodiment of the present invention as illustrated in FIG. 1, having a rack-mountable form factor that comprises a plurality of source and target RJ45 connectors.

FIG. 9 is a perspective view of an alternative embodiment of the present invention as illustrated in FIG. 6, having a rack-mountable form factor that comprises a plurality of source and target fiber connectors.

### DETAILED DESCRIPTION OF THE INVENTION

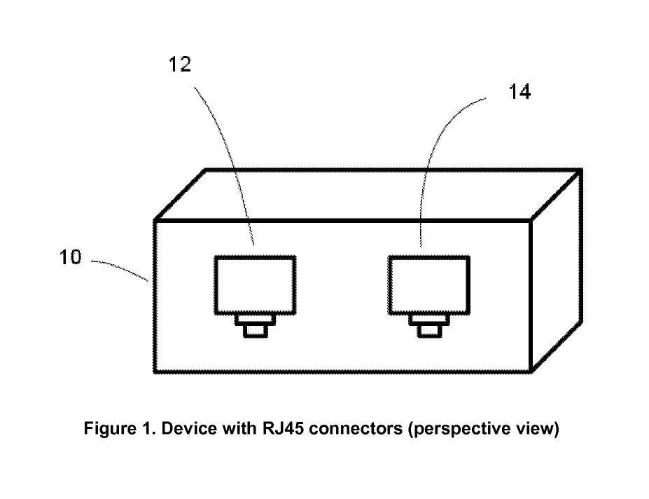

FIG. 1 presents a preferred embodiment of the device 10 of the present invention. The device may have an exterior enclosure that can be made of any material, preferably plastic or metal. It can be any size or shape, preferably a size or shape that is the most space efficient. The device may have a source 12 receptacle in the form of an RJ45 connector and a target 14 receptacle the form of an RJ45 connector. The source and the target receptacles can be located anywhere on the enclosure, preferably at locations that offer best access. The device may have at least one circuitry to enable network traffic to move from the source to the target, but no circuitry to enable traffic to move from the target to the source.

This is the preferred embodiment of this invention, particularly because RJ45 connectors are extremely economical and widely used in all networks. In fact, cost effectiveness is one of the primary differentiators and motivators of this invention, which is a huge contrast to conventional methods disclosed in the prior art. Case in point: a complete and fully functioning prototype of this embodiment costs less than five US dollars to assemble at the time of this disclosure.

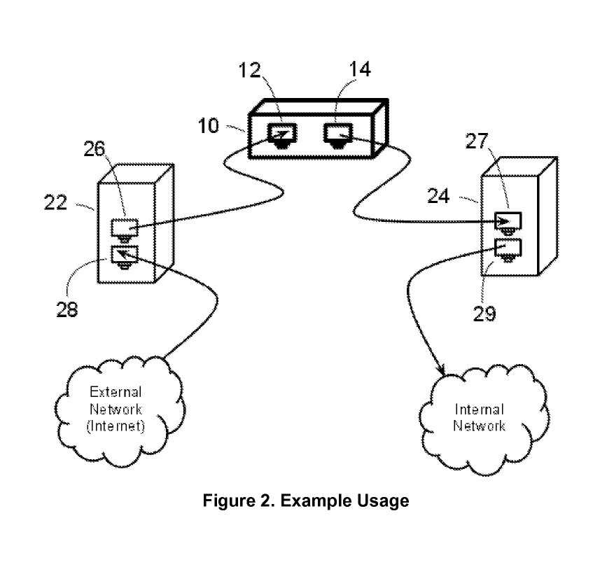

FIG. 2 shows a basic method of use to illustrate the usefulness of this invention. A source computer 22 comprises a plurality of network adapters, one 28 of which may be connected directly or indirectly to an external network, such as the Internet, and one 26 of which is connected to the source 12 receptacle of the present invention. The source computer 22 may download content (such as data and applications) from the Internet and may use a connectionless protocol (such as UDP) to transmit the content to the device 10 of the present invention. The content enters the source 12 receptacle, exits the target 14 receptacle, and makes its way to the target computer 24 via one 27 of a plurality of network adapters attached to the target computer 24. Once the content arrives at the target computer 24, it can then be stored on a network share on the internal network so that all devices on the internal network may make use of the content.

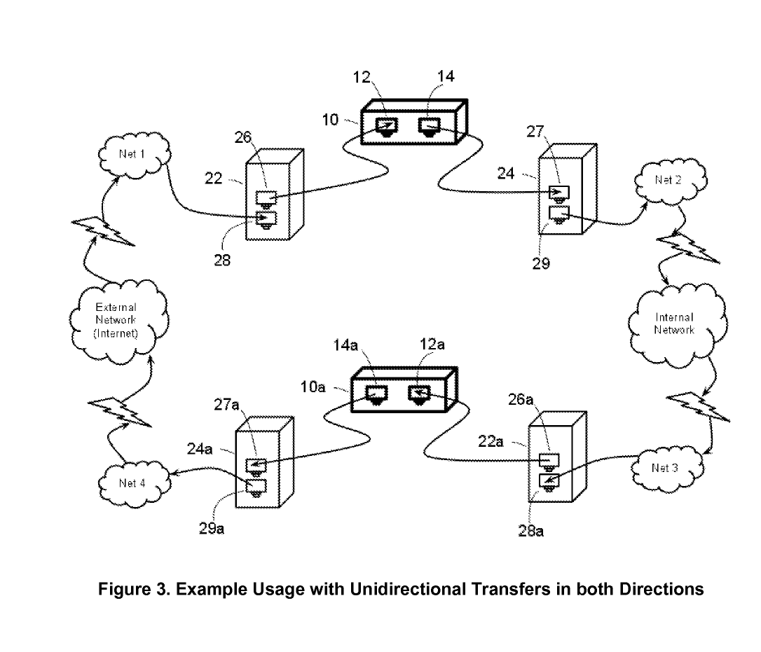

While FIG. 2 only shows how data may be transferred from an external network into an internal network in a controlled manner, you can use a similar approach to control the transferring of data from an internal to an external network, as illustrated in FIG. 3, which shows a system with two devices 10, boa of the present invention. Each device has a source 12, 12a and a target 14, 14a receptacle, wherein data may flow only from the source 12, 12a receptacle to the target 14, 14a receptacle. One device 10 can transfer data from an external network to an internal network, either directly or indirectly, and another device boa can transfer data from an internal network to an external network, either directly or indirectly.

The system in FIG. 3 also comprises a plurality of source computers 22, 22a. Each source computer 22, 22a comprises a plurality of network adapters, one 28, 28a of which may be connected to a source network and another 26, 26a of which may be connect to a source 12, 12a receptacle of one of said devices 10, boa of the present invention. Each source computer 22, 22a may comprise software that may use certificates for authentication, authorization, integrity, verification, and privacy. Each source computer 22, 22a may comprise software that may verify sender signatures, check data for malware, validate data formats, redact data contents, encode data content, and transmit data to the source 12, 12a receptacle. Each source computer 22, 22a may comprise software that may transmit out-of-band acknowledgements to support guaranteed delivery.

The system in FIG. 3 also comprises plurality of target computers 24, 24a. Each target computer 24, 24a comprises a plurality of network adapters, one of which 29, 29a may be connected to a target network and another 27, 27a of which may be connect to a target 14, 14a receptacle of one of said devices 10, boa of the present invention. Each target computer 24, 24a may comprise software that may use certificates for authentication, authorization, integrity, verification, and privacy. Each target computer 24, 24a may comprise software that may receive data from the target 14, 14a receptacle, verify data integrity, decode data content, check data for malware, and validate data formats. Each target computer 24, 24a may comprise software that may receive and handle out-of-band acknowledgements to support guaranteed delivery.

The system in FIG. 3 also comprises a plurality of networks, wherein each network may be a security boundary only accessible by computers belonging to said network. A plurality of these networks may comprise a plurality of source computers 22, 22a that may transmit data to a plurality of source 12, 12a receptacles of a plurality of devices 10, boa of the present invention. A plurality of these networks may comprise a plurality of target computers 24, 24a that may receive data from a plurality of target 14, 14a receptacles of a plurality of devices 10, boa of the present invention.

The system in FIG. 3 also comprises a plurality of firewalls, wherein each firewall may protect one network from another. A plurality of firewalls may be configured to prevent specific external network traffic from entering the internal network. A plurality of firewalls may be configured to prevent specific internal network traffic from exiting the internal network. These firewall configurations are important to prevent a complete and seamless round trip. By using certificates for authentication, authorization, integrity, verification, and privacy, and by using virus scanning software to prevent malware, only safe data may enter the internal network, and only approved and signed data may exit the internal network.

Summing up, with appropriate software, networking, and firewall configuration, the method illustrated in FIG. 3 offers controlled unidirectional transfers in both directions. It can also offer guaranteed delivery with appropriate use of software that supports out-of-band acknowledgements. Take advantage of certificates for authentication, authorization, integrity, verification, and privacy, and you will have a very secure controlled transfer system. Of course, this setup is more appropriate for commercial or federal systems, because it requires a plurality of networks and advanced configurations that may be unrealistic for basic home use.

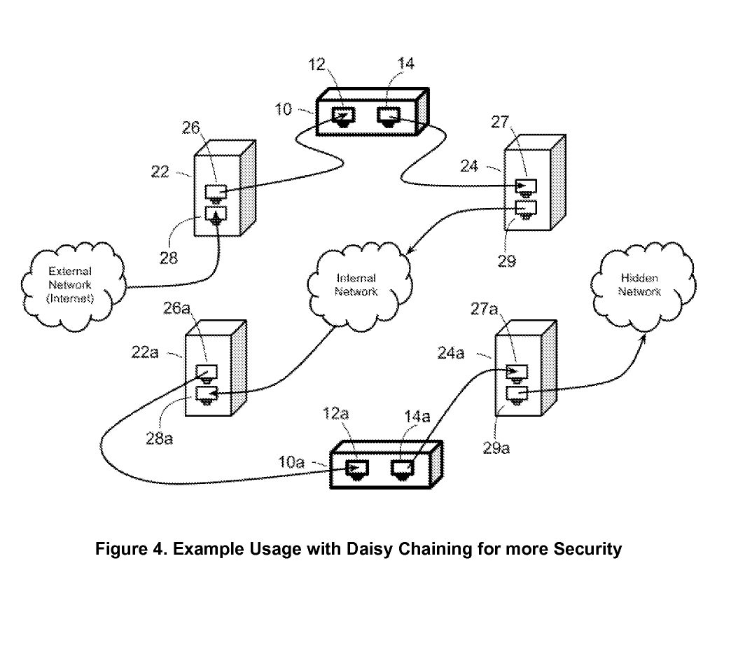

Alternatively, it is possible to daisy chain a plurality of devices of this invention, similar to the drawing in FIG. 4. This is a quick, simple, and inexpensive way to add layers and layers of networks and security.

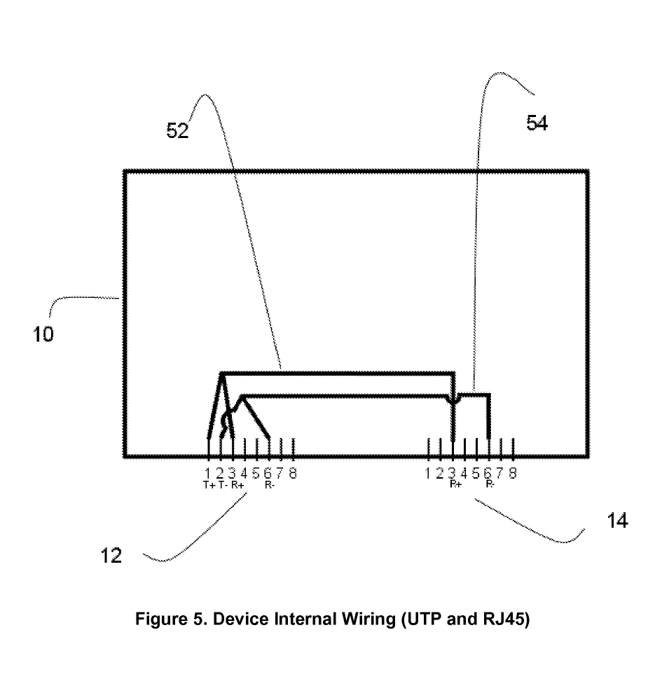

FIG. 5 shows possible internal wiring and connections inside the enclosure of the device 10 of the present invention. The source 12 and target 14 receptacles may be conventional RJ45 keystone jacks with all 8 pins, or unconventional ones custom made to expose only pins 1, 2, 3, and 6 for the source 12 receptacle and only pins 3 and 6 for the target 14 receptacle. In either case, a conductor 52, preferably a copper wire, can be used to connect pin 1 of the source 12 receptacle to pin 3 of the source 12 receptacle and to pin 3 of the target 14 receptacle. Also, a conductor 54 can be used to connect pin 2 of the source 12 receptacle to pin 6 of the source 12 receptacle and to pin 6 of the target 14 receptacle. These conductors 52, 54 should be twisted per standard specifications, preferably CAT5. Since pins 1 and 2 are used for transmission, and pins 3 and 6 are used for reception, as shown in FIG. 5, both of these conductors 52, 54 permit traffic to move from the source 12 to the target 14. However, no conductors exist to move data from the target 14 to the source 12, thus providing no reverse path of communication. In other words, data can move only from the source 12 to the target 14, never from the target 14 to the source 12.

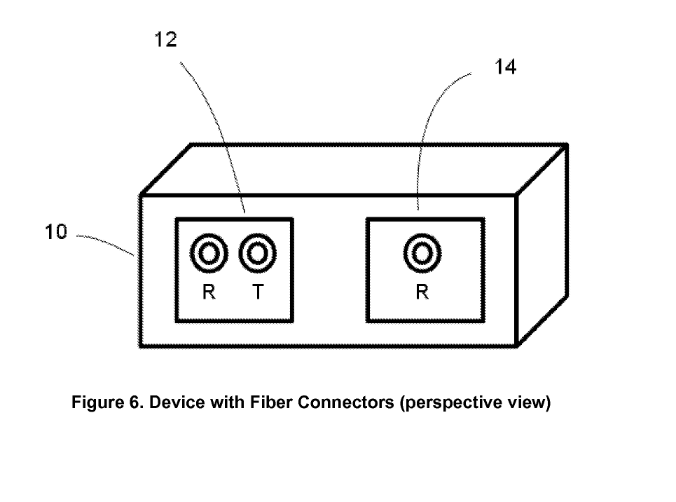

FIG. 6 shows a different embodiment of the device 10 of the present invention shown in FIG. 1, this time utilizing optical fiber connectors. This embodiment may have an exterior enclosure that can be made of any material, preferably plastic or metal. It can be any size or shape, preferably a size or shape that is the most space efficient. This embodiment may have a source 12 receptacle in the form of two optical fiber connectors and a target 14 receptacle in the form of a single optical fiber connector. The advantage of this embodiment is higher bandwidth, but the disadvantage is it may require the source and target computers to have optical fiber network adapters, which are less common and more expensive than Ethernet adapters.

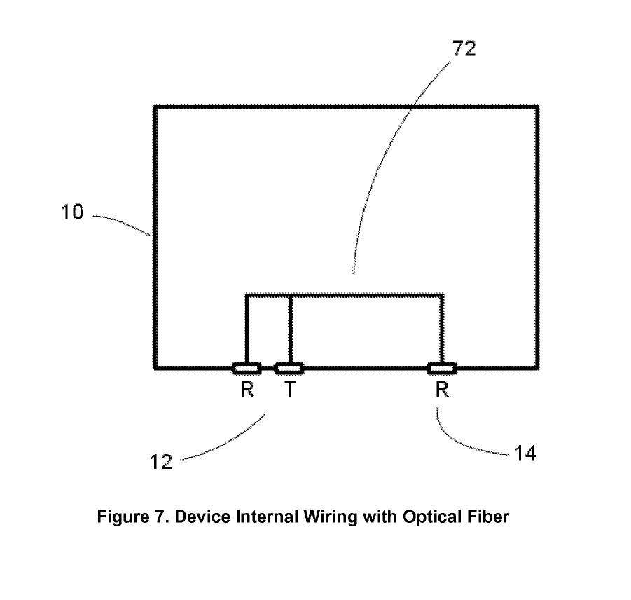

FIG. 7 shows a possible way to connect optical cables inside the enclosure of the device 10 of the present invention. The source 12 receptacle comprises two optical connectors, one for transmission and one for reception. The target 14 receptacle comprises a single optical fiber connector, solely for reception. An optical fiber Y cable 72 can be used to connect the transmission connector of the source 12 receptacle to the reception connector of the source 12 receptacle and to the reception connector of the target 14 receptacle. The optical fiber Y cable 72 permits traffic to move from the source 12 to the target 14. However, since the target 14 receptacle contains no transmission connector, no traffic can flow in the reverse direction. In other words, data can move only from the source 12 to the target 14, never from the target 14 to the source 12.

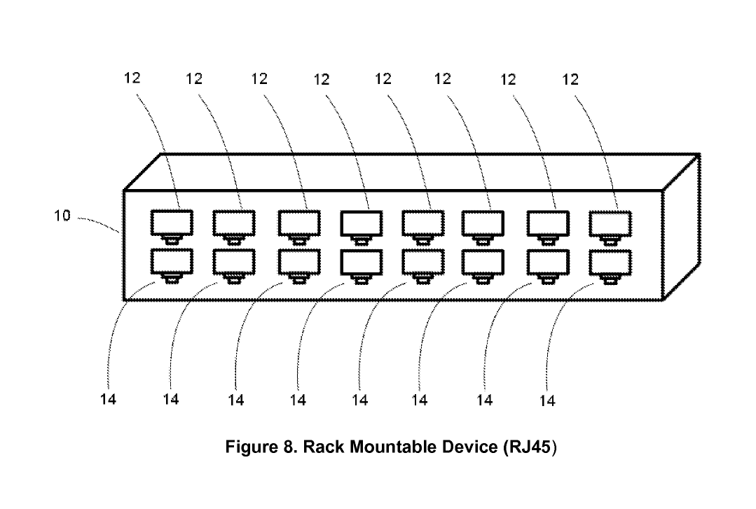

FIG. 8 shows a different embodiment of the device 10 of the present invention shown in FIG. 1, this time utilizing a form factor that may be rack mountable. This embodiment may have an exterior enclosure that can be made of any material, preferably metal. It can be any size or shape, preferably a size or shape that is rack mountable. This embodiment may have a plurality of source 12 receptacles in the form of RJ45 connectors and a plurality of target 14 receptacles in the form of RJ45 connectors. Internally, this embodiment comprises a plurality of conductors for transferring data from said sources to said targets, but no conductors for transferring data from said targets to said sources. This embodiment may allow this device to be mounted in a server rack. It also allows for more redundancy, reliability, scalability, and availability.

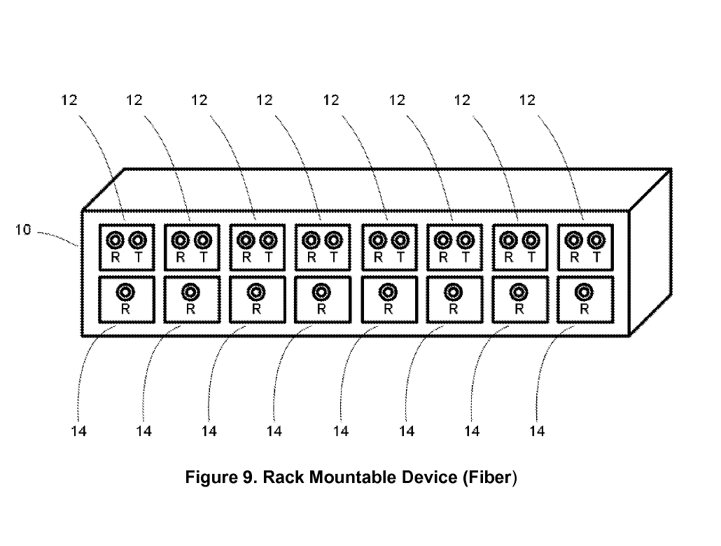

FIG. 9 shows a different embodiment of the device 10 of the present invention shown in FIG. 6, this time utilizing a form factor that may be rack mountable. This embodiment may have an exterior enclosure that can be made of any material, preferably metal. It can be any size or shape, preferably a size or shape that is rack mountable. This embodiment may have a plurality of source 12 receptacles, each having two optical fiber connectors. It may have a plurality of target 14 receptacles, each having one optical fiber connector for the purpose of receiving data, but no optical fiber connectors for the purpose of transferring data. Internally, this embodiment comprises a plurality of optical fiber Y cables, each of which connects to the three optical fiber connectors associated with each source and target pair. This embodiment may allow this device to be mounted in a server rack. It also allows for more redundancy, reliability, scalability, and availability.

The present invention claims:

1. A highly cost-effective device for transferring data unidirectionally comprising:
an exterior enclosure that can be made of any material, preferably plastic or metal, and can be any size or form factor that is most space efficient;
a source having at least one connector and may be located anywhere on the enclosure, preferably at a location that offers best access;
a target having one connector and may be located anywhere on the enclosure, preferably at a location that offers best access;
no circuitry to enable network traffic to move from said target to said source;
at least one circuitry to enable network traffic to move from said source to said target, wherein:
said circuitry comprises a plurality of conductors, preferably copper wires;
said source may be an RJ45 receptacle;
said target may be an RJ45 receptacle;
said receptacles can be conventional RJ45 keystone jacks or unconventional ones that are custom made to expose only pins 1, 2, 3, and 6 for said source, and only pins 3 and 6 for said target;
one of said conductors should connect pin 1 of said source to pin 3 of said source and to pin 3 of said target;
another of said conductors should connect pin 2 of said source to pin 6 of said source and to pin 6 of said target; and
said conductors should be twisted per standard specifications, preferably CAT5.

2. The device of claim 1 having an alternative embodiment further comprising:
an exterior enclosure that can be made of any material, preferably metal, and can be any size or form factor, preferably a size and a form factor that is rack mountable;
a plurality of sources that may be RJ45 receptacles;
a plurality of targets that may be RJ45 receptacles;
a plurality of conductors for transferring data from said sources to said targets; and
no conductors for transferring data from said targets to said sources.

3. A cost-effective device for transferring data unidirectionally comprising:
an exterior enclosure that can be made of any material, preferably plastic or metal, and can be any size or form factor that is most space efficient;
a source having at least one connector and may be located anywhere on the enclosure, preferably at a location that offers best access;
a target having one connector and may be located anywhere on the enclosure, preferably at a location that offers best access;
no circuitry to enable network traffic to move from said target to said source;
at least one circuitry to enable network traffic to move from said source to said target, wherein:
said circuitry may be a single optical fiber Y cable;
said source may be an optical fiber receptacle;
said target may be an optical fiber receptacle;
said source receptacle may comprise two optical fiber connectors, one for transmission and one for reception;
said target receptacle may comprise a single optical fiber connector for the purpose of receiving data but may intentionally lack an optical fiber connector for the purpose of transferring data; and
said single optical fiber Y cable connects said source transmission connector to said source reception connector and to said target reception connector.

4. The device of claim 3 having an alternative embodiment further comprising:
an exterior enclosure that can be made of any material, preferably metal, and can be any size or form factor, preferably a size and a form factor that is rack mountable;
a plurality of sources that may be optical fiber receptacles, each having two optical fiber connectors;
a plurality of targets that may be optical fiber receptacles, each having one optical fiber connector for the purpose of receiving data, but no optical fiber connectors for the purpose of transferring data; and
a plurality of optical fiber Y cables, each of which connects to the three optical fiber connectors associated with each source and target pair.

5. A system for any embodiments of this invention comprising:
a plurality of devices of the present invention, wherein:
each said device has a source receptacle and a target receptacle;
data may flow only from the source receptacle to the target receptacle;
a plurality of said devices can transfer data from an external network to an internal network, either directly or indirectly;
a plurality of said devices can transfer data from an internal network to an external network, either directly or indirectly;
a plurality of said devices can be daisy chained in a plurality of ways, such as from one computer to another computer, or from one computer to a network to another computer, for obscurity and security;
a plurality of source computers, wherein:
each source computer comprises a plurality of network adapters, one of which may be connected to a source network and another of which may be connected to a source receptacle of one of said devices of the present invention;
each source computer may comprise software that may use certificates for authentication, authorization, integrity, verification, and privacy;
each source computer may comprise software that may verify sender signatures, check data for malware, validate data formats, redact data contents, encode data content, and transmit data to the source receptacle;
each source computer may comprise software that may transmit out-of-band acknowledgements to support guaranteed delivery;
a plurality of target computers, wherein:
each target computer comprises a plurality of network adapters, one of which may be connected to a target network and another of which may be connected to a target receptacle of one of said devices of the present invention;
each target computer may comprise software that may use certificates for authentication, authorization, integrity, verification, and privacy;
each target computer may comprise software that may receive data from the target receptacle, verify data integrity, decode data content, check data for malware, and validate data formats;
each target computer may comprise software that may receive and handle out-of-band acknowledgements to support guaranteed delivery;
a plurality of networks, wherein:
each network may be a security boundary only accessible by computers belonging to said network;
each network may comprise a plurality of source computers that may transmit data to a plurality of source receptacles of devices of the present invention;
each network may comprise a plurality of target computers that may receive data from a plurality of target receptacles of devices of the present invention;
a plurality of firewalls, wherein:
each firewall may protect one of said networks from another;
each firewall may be configured to prevent specific external traffic from entering an internal network;
each firewall may be configured to prevent specific internal traffic from exiting an internal network; and
a plurality of certificates, wherein each certificate may be used for authentication, authorization, integrity, verification, and privacy.
